(19) United States
(12) Patent Application Publication
(10) Pub. No.: US 2025/0384311 A1
(43) Pub. Date: Dec. 18, 2025

(54) KNOWLEDGE GRAPH-BASED INFERENCE METHOD AND APPARATUS

(71) Applicant: Alipay (Hangzhou) Information Technology Co., Ltd., Hangzhou (CN)

(72) Inventor: Shaofei WANG, Hangzhou (CN)

(21) Appl. No.: 19/225,213

(22) Filed: Jun. 2, 2025

(30) Foreign Application Priority Data
Jun. 18, 2024 (CN) 202410787478.7

(51) Int. Cl. G06N 5/04; G06N 5/025

(52) U.S. Cl. CPC G06N 5/04; G06N 5/025

(57) ABSTRACT

A knowledge graph-based inference method includes: receiving an inference request from a user equipment, where the inference request includes a user-defined virtual edge generation rule, and the generation rule includes node constraints on a start node and an end node of a virtual edge, and a relationship constraint on a relationship between the start node and the end node; determining, based on the generation rule, the virtual edge between a first node and a second node that do not have an actual connecting edge in the knowledge graph; and performing, based on the virtual edge, graph inference specified in the inference request.

### CROSS-REFERENCE TO RELATED APPLICATIONS

This application claims priority to Chinese Patent Application No. 202410787478.7, filed on Jun. 18, 2024, the entire content of which is incorporated herein by reference.

### TECHNICAL FIELD

Embodiments of this specification relate to the field of computer technologies, and in particular, to a knowledge graph-based inference method and apparatus.

### BACKGROUND

A knowledge graph can be understood as a semantic network that describes entities and relationships between the entities in the real world in a graph pattern. Currently, in inference use of the knowledge graph, a user needs to define an expected inference pattern. The pattern describes a connection and a constraint relationship between nodes/edges in the knowledge graph. In graph inference, the pattern is used as a reference to calculate all actual data that conforms to the pattern. When an inference requirement of the user changes, an actual connecting edge needs to be constructed first. This results in an increase in use costs of user inference and a waste of constructing and storing graph data.

Therefore, a proper and reliable solution is urgently needed to meet a dynamic inference requirement of the user and lower costs of constructing and storing graph data.

### SUMMARY

According to a first aspect, an embodiment of this specification provides a knowledge graph-based inference method, including: receiving an inference request from a user, where the inference request includes a user-defined virtual edge generation rule, and the generation rule includes node constraints on a start node and an end node of a virtual edge, and a relationship constraint on a relationship between the start node and the end node; determining, based on the generation rule, the virtual edge between a first node and a second node that do not have an actual connecting edge in the knowledge graph; and performing, based on the virtual edge, graph inference specified in the inference request.

According to a second aspect, an embodiment of this specification provides a knowledge graph-based inference apparatus, including: a processor; and a memory storing instructions executable by the processor. The processor is configured to: receive an inference request from a user equipment, where the inference request includes a user-defined virtual edge generation rule, and the generation rule includes node constraints on a start node and an end node of a virtual edge, and a relationship constraint on a relationship between the start node and the end node; determine, based on the generation rule, the virtual edge between a first node and a second node that do not have an actual connecting edge in the knowledge graph; and perform, based on the virtual edge, graph inference specified in the inference request.

According to a third aspect, an embodiment of this specification provides a non-transitory computer-readable storage medium. The computer-readable storage medium stores a computer program, and when the computer program is executed by a processor, the processor is caused to perform the method according to the first aspect.

In the embodiments of this specification, a user is supported in defining a virtual edge generation rule, and the generation rule is included in an inference request. Therefore, a virtual edge can be determined, based on the generation rule in the inference request, between a first node and a second node that do not have an actual connecting edge in a knowledge graph, and graph inference specified in the inference request can be performed based on the virtual edge. In this way, in an inference process, there is no need to strongly depend on an actual connecting edge in the knowledge graph, and it can meet a dynamic inference requirement of the user and lower costs of constructing and storing graph data. Accordingly, utilization of an existing knowledge graph can be improved, and memory space can be saved by not constructing a complete new knowledge graph for storing graph data.

### BRIEF DESCRIPTION OF DRAWINGS

The following briefly describes the accompanying drawings of this specification.

Clearly, the accompanying drawings in the following descriptions show merely example embodiments of this specification.

FIG. 1 is a schematic diagram of an application scenario of a knowledge graph-based inference method, according to an embodiment.

FIG. 2 is a schematic diagram of a graph pattern and graph data of a knowledge graph, according to an embodiment.

FIG. 3 is a flowchart of a knowledge graph-based inference method, according to an embodiment.

FIG. 4 is a flowchart of a knowledge graph-based inference method, according to an embodiment.

FIG. 5 is a schematic diagram of a knowledge graph-based inference apparatus, according to an embodiment.

FIG. 6 is a schematic diagram of a knowledge graph-based inference apparatus, according to an embodiment.

### DETAILED DESCRIPTION OF EMBODIMENTS

The following further describes example embodiments of this specification in detail with reference to the accompanying drawings. It can be understood that the specific embodiments described herein are merely intended to explain the related invention, but are not intended to limit the invention. The described embodiments are merely some but not all of the embodiments of this specification. All other embodiments obtained by a person of ordinary skill in the art based on the embodiments of this specification without creative efforts shall fall within the protection scope of this specification.

It should be noted that for ease of description, only parts related to the related invention are shown in the accompanying drawings. When there is no conflict, the embodiments of this specification and features in the embodiments can be combined with each other. In addition, words such as “first”, “second”, and “third” in the embodiments of this specification are merely used for information differentiation, and do not constitute any limitation.

As described above, when an inference requirement of a user changes, an actual connecting edge needs to be constructed first. This results in an increase in use costs of user inference and a waste of constructing and storing graph data.

Embodiments of this specification provide a knowledge graph-based inference solution, to meet a dynamic inference requirement of a user and lower costs of constructing and storing graph data.

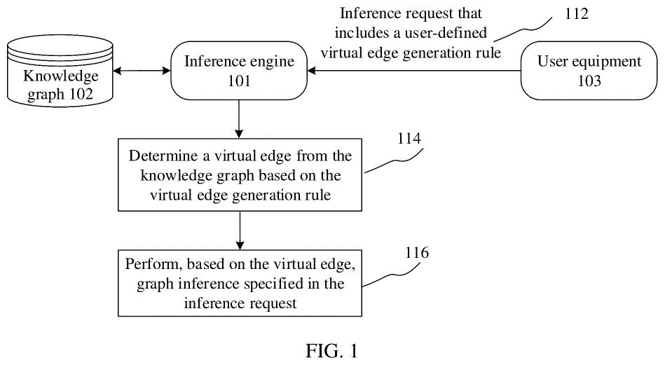

FIG. 1 is a schematic diagram of an application scenario of a knowledge graph-based inference method, according to an embodiment. The application scenario relates to an inference engine 101, a knowledge graph 102, and user equipment 103 used by a user with an inference requirement. The knowledge graph 102 can be stored in the inference engine 101, or can be stored at another location, for example, a storage system that can communicate with the inference engine 101.

The knowledge graph 102 can be a knowledge graph in any scenario, including, for example, a recommendation scenario, a medical scenario, a risk control scenario, or another scenario. This is not specifically limited herein. The knowledge graph 102 can include nodes of a plurality of node types and an actual connecting edge between nodes.

In a recommendation scenario, the knowledge graph 102 can be used, for example, in an e-commerce platform for making recommendations to users of the e-commerce platform. Each node type in the knowledge graph 102 can include, for example, a user, a merchant, a product, a store, and a product type, and an actual connecting edge between nodes can represent a relationship such as Belongs, Clicks, or Collects.

In a medical scenario, each node type in the knowledge graph 102 can include, for example, an examination item, a symptom, a diagnosis result, and a treatment method, and an actual connecting edge between nodes can represent a relationship such as Derives or Belongs.

In a risk control scenario, the knowledge graph 102 can be used, for example, in an electronic transaction platform for risk control, and various types of related information of a user and various types of related information of a transaction are included. For example, the various types of related information of the user can include attributes such as a location and a credit card number of the user, and the various types of related information of the transaction can include information such as a credit card number involved in the transaction and a bank to which the credit card number belongs. In such a case, each node type in the knowledge graph 102 can include, for example, User, CreditCard, and Bank, and an actual connecting edge between nodes can represent a relationship such as Belongs. Any node records node information. The node information can include a node identifier (ID) of the any node, attribute information of several attributes, a node type to which the node belongs, etc.

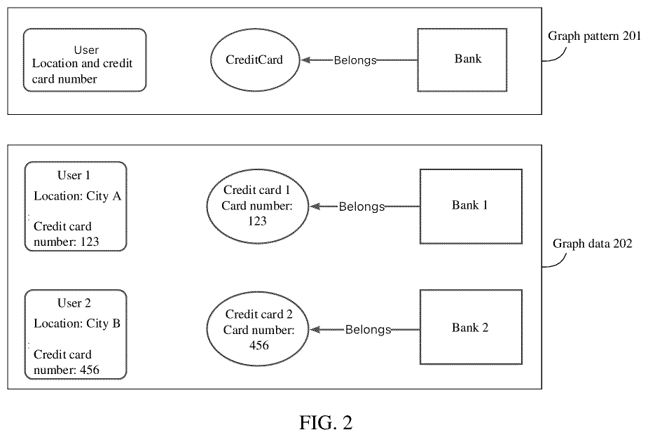

It should be noted that for a type of node in the knowledge graph 102, the knowledge graph 102 includes another type of node that does not have an actual connecting edge with the type of node. An example in which a graph pattern and graph data of the knowledge graph 102 are a graph pattern 201 and graph data 202 shown in FIG. 2 is used. In the knowledge graph 102, there is no actual connecting edge between a node of the node type User and each of a node of the node type CreditCard and a node of the node type Bank.

FIG. 2 is an example schematic diagram of the graph pattern and the graph data of the knowledge graph 102. As shown in FIG. 2, the graph pattern 201 defines node types such as User, CreditCard, and Bank, attributes such as a location and a credit card number corresponding to the node type User, and an actual connecting edge whose type is Belongs between the two node types CreditCard and Bank. The graph data 202 includes a user 1 node and a user 2 node that belong to the node type User, a credit card 1 node and a credit card 2 node that belong to the node type CreditCard, a bank 1 node and a bank 2 node that belong to the node type Bank, an actual connecting edge whose type is Belongs between the credit card 1 node and the bank 1 node, and an actual connecting edge whose type is Belongs between the credit card 2 node and the bank 2 node. The user 1 node records an attribute value “City A” of a location attribute of a user 1 represented by the user 1 node, and an attribute value “123” of a credit card number attribute. The user 2 node records an attribute value “City B” of a location attribute of a user 2 represented by the user 2 node, and an attribute value “456” of a credit card number attribute. The credit card 1 node records a card number “123” of a credit card 1 represented by the credit card 1 node, and the card number is used as a node ID of the credit card 1 node. The credit card 2 node records a card number “456” of a credit card 2 represented by the credit card 2 node, and the card number is used as a node ID of the credit card 2 node.

In the application scenario shown in FIG. 1, when an inference requirement of the user changes, the user can define a virtual edge generation rule based on an actual inference requirement. The virtual edge generation rule includes node constraints on a start node and an end node of a virtual edge, and a relationship constraint on a relationship between the start node and the end node. Then, the user can send (112) an inference request to the inference engine 101 by using the used user equipment 103. The inference request includes the virtual edge generation rule. Then, the inference engine 101 can determine (114) the virtual edge in the knowledge graph 102 based on the virtual edge generation rule, and perform (116), based on the virtual edge, graph inference specified in the inference request.

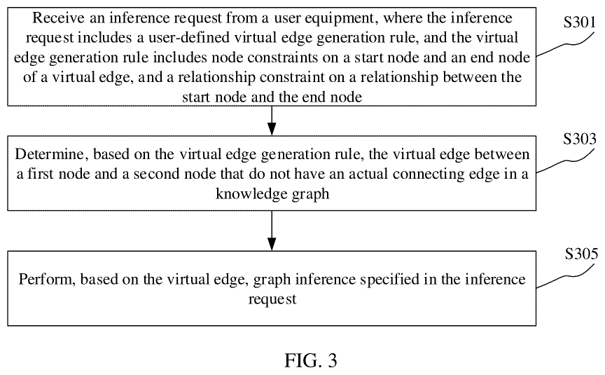

FIG. 3 is a flowchart of a knowledge graph-based inference method according to an embodiment. The method can be performed by the inference engine 101 and includes steps S301 to S305 as an example.

In step S301, an inference request is received from a user equipment, where the inference request includes a user-defined virtual edge generation rule, and the virtual edge generation rule includes node constraints on a start node and an end node of a virtual edge, and a relationship constraint on a relationship between the start node and the end node.

The node constraints can have different implementations. In an example, the node constraints can include at least a first-type constraint on the start node and a second-type constraint on the end node. In another example, the node constraints can include an identifier of a specified start node and a target constraint on the end node. The target constraint can include, for example, an identifier of a specified end node or a type constraint on the end node. For example, when the end node of the virtual edge further needs to be edge-connected to another node, the end node of the virtual edge can be a specified end node or a specific type of node, and therefore the target constraint can include the identifier of the specified end node or the type constraint on the end node. When the end node of the virtual edge does not need to be edge-connected to another node, the end node of the virtual edge can be a type of node, and therefore the target constraint can include the type constraint on the end node.

The relationship constraint can also have different implementations. For example, the relationship constraint can be a default preset logical relationship. The preset logical relationship can include that a node ID of the end node is equal to a specific attribute value of the start node. For another example, the relationship constraint can be defined based on an objective function, and the objective function is used to constrain an attribute of the start node and/or an attribute of the end node.

It should be noted that a function body of the objective function has relationship constraint logic for the relationship between the start node and the end node of the virtual edge. The objective function can be a built-in function or a custom function. When the target function is a built-in function, the target function is prestored in the inference engine 101. When the target function is a custom function, the target function can be prestored in the inference engine 101 or included in the virtual edge generation rule. When the objective function is prestored in the inference engine 101, the objective function can be introduced into the virtual edge generation rule, so that the start node and the end node are used as input parameters of the objective function, to enable the virtual edge generation rule to include the relationship constraint on the relationship between the start node and the end node of the virtual edge.

Then, in step S303, the virtual edge is determined, based on the virtual edge generation rule, between a first node and a second node that do not have an actual connecting edge in the knowledge graph 102.

For example, in the knowledge graph 102, a node that meets the node constraint on the start node can be determined as the first node, a node that meets the node constraint on the end node and that has the relationship constraint with the first node can be determined as the second node, and the virtual edge can be established between the first node and the second node.

Further, when the node constraints include at least the first-type constraint on the start node and the second-type constraint on the end node, the first node can be determined based on the first-type constraint, a candidate node can be determined based on the second-type constraint, a node that has the relationship constraint with the first node can be determined as the second node from the candidate node, and the virtual edge can be established between the first node and the second node. It should be noted that the determined first node can be one or more first nodes. For each determined first node, a second node that has the relationship constraint with the first node can be one or more second nodes. The virtual edge can be established between the first node and each second node that has the relationship constraint with the first node. The virtual edge can be represented by using an ID pair including node IDs of the first node and the second node.

When the node constraints include the identifier of the specified start node and the target constraint on the end node, the first node can be determined based on the identifier, a node that has the relationship constraint with the first node can be determined as the second node from a candidate node that meets the target constraint, and the virtual edge can be established between the first node and the second node.

Then, in step S305, graph inference specified in the inference request is performed based on the virtual edge.

In an example, when the inference request requests to obtain node information of the end node of the virtual edge, node information of the second node can be obtained from the knowledge graph 102, and an inference result can be generated based on the obtained node information.

In another example, when the inference request requests to obtain node information of a third node that has an actual connecting edge with the end node of the virtual edge, a third node that has an actual connecting edge with the second node can be determined from the knowledge graph 102, node information of the third node can be obtained, and then an inference result can be generated based on the obtained node information.

The following describes the embodiment of FIG. 3 by using an example in which a graph pattern and graph data of the knowledge graph 102 are the graph pattern 201 and the graph data 202 shown in FIG. 2.

In an example, it is assumed that there is an inference requirement to infer a bank to which a credit card of a user described in the knowledge graph 102 belongs. Because there is no actual connecting edge between a node of a node type User and a node of a node type CreditCard in the knowledge graph 102, a virtual edge generation rule can be defined to include a first-type constraint used to limit a node type of a start node of a virtual edge to User, a second-type constraint used to limit a node type of an end node of the virtual edge to CreditCard, and a relationship constraint used to limit a node ID of the end node to be equal to an attribute value of a credit card number attribute of the start node. Then, an inference request can be sent to the inference engine 101, where the inference request includes the generation rule, and requests to obtain node information of a node that has an actual connecting edge with the end node of the virtual edge and that belongs to a node type Bank.

It is assumed that the inference engine 101 stores an objective function, and input parameters of the objective function include a first parameter used to represent the node of the node type User and a second parameter used to represent the node of the node type CreditCard. The relationship constraint is specifically defined in a function body of the objective function. For example, Function represents a function name of the objective function, user represents the first parameter, and card represents the second parameter. A function entry of the objective function can be Function (User user, CreditCard card). The inference request can include, for example,
(user:User)-[edge1:Function(user,card)]->(card:CreditCard)<-[edge2: Belongs]-(bank:Bank).

Herein, content from (user:User) to (card:CreditCard) can be considered as the virtual edge generation rule. Herein, (user:User) is the first-type constraint on the start node, user is a parameter used to represent the start node, and User is a node type to which the start node belongs; (card:CreditCard) is the second-type constraint on the end node, card is a parameter used to represent the end node, and CreditCard is a node type to which the end node belongs; Function(user,card) can be considered as a relationship constraint on a relationship between the start node and the end node; and edge1 is a parameter used to represent a connecting edge between the node of the node type User and the node of the node type CreditCard. It should be noted that in a subsequent process of performing the inference request, it can be learned, based on Function(user,card), that edge1 actually represents a virtual edge. Herein, bank is a parameter used to represent the node of the node type Bank; edge2 is a parameter used to represent a connecting edge between the node of the node type CreditCard and the node of the node type Bank; and Belongs is an edge type to which the connecting edge represented by edge2 belongs. In the subsequent process of performing the inference request, it can be learned, based on Belongs, that edge2 actually represents an actual connecting edge whose type is Belongs.

After receiving the inference request, the inference engine 101 can determine a user 1 node and a user 2 node that meet the first-type constraint, and a credit card 1 node and a credit card 2 node that meet the second-type constraint from the knowledge graph 102. Then, by comparing a node ID “123” of the credit card 1 node with an attribute value “123” of a credit card number attribute of the user 1 node, the inference engine 101 can determine that the node ID “123” is the same as the attribute value “123”, and therefore determine that the credit card 1 node and the user 1 node have the relationship constraint, and establish a virtual edge e1 from the user 1 node to the credit card 1 node. In addition, by comparing a node ID “456” of the credit card 2 node with an attribute value “456” of a credit card number attribute of the user 2 node, the inference engine 101 can determine that the node ID “456” is the same as the attribute value “456”, and therefore determine that the credit card 2 node and the user 2 node have the relationship constraint, and establish a virtual edge e2 from the user 2 node to the credit card 2 node. Then, the inference engine 101 can determine a bank 1 node that has an actual connecting edge with an end node (that is, the credit card 1 node) of the virtual edge e1 from the knowledge graph 102 based on a node ID of the end node and the edge type Belongs, and obtain node information of the bank 1 node. The node information includes but is not limited to a name of a bank represented by the bank 1 node. In addition, the inference engine 101 can further determine a bank 2 node that has an actual connecting edge with an end node (that is, the credit card 2 node) of the virtual edge e2 from the knowledge graph 102 based on a node ID of the end node and the edge type Belongs, and obtain node information of the bank 2 node. Then, the inference engine 101 can generate an inference result based on the obtained node information. The inference result can indicate that a bank to which a credit card of a user 1 belongs includes a bank 1, and a bank to which a credit card of a user 2 belongs includes a bank 2.

In another example, it is assumed that there is an inference requirement to infer a credit card number owned by a user 1. A virtual edge generation rule can be defined to include a node ID of a specified start node (that is, a user 1 node), a type constraint used to limit a node type of an end node of a virtual edge to CreditCard, and a relationship constraint used to limit a node ID of the end node to be equal to an attribute value of a credit card number attribute of the start node. Then, an inference request can be sent to the inference engine 101, where the inference request includes the generation rule, and requests to obtain node information of the end node of the virtual edge. After receiving the inference request, the inference engine 101 can determine the user 1 node from the knowledge graph 102 based on the node ID of the specified start node, and determine a credit card 1 node and a credit card 2 node from the knowledge graph 102 based on the type constraint. Then, by comparing respective node IDs of the credit card 1 node and the credit card 2 node with an attribute value “123” of a credit card number attribute of the user 1 node, the inference engine 101 can learn that only the credit card 1 node has the relationship constraint with the user 1 node, and therefore establish a virtual edge e1 from the user 1 node to the credit card 1 node. Then, the inference engine 101 can obtain node information of an end node (that is, the credit card 1 node) of the virtual edge e1. The node information includes but is not limited to a card number of a credit card 1. Then, the inference engine 101 can generate an inference result based on the obtained node information. The inference result can indicate that the user 1 owns the credit card number “123”.

In the embodiment in FIG. 3, a user is supported in defining a virtual edge generation rule, and the generation rule is included in an inference request. Therefore, a virtual edge can be determined, based on the generation rule in the inference request, between a first node and a second node that do not have an actual connecting edge in a knowledge graph, and graph inference specified in the inference request can be performed based on the virtual edge. In this way, in an inference process, there is no need to strongly depend on an actual connecting edge in the knowledge graph, and it can meet a dynamic inference requirement of the user and lower costs of constructing and storing graph data. Accordingly, utilization of an existing knowledge graph can be improved, and memory space can be saved by not constructing a complete new knowledge graph for storing graph data.

In an embodiment, to better meet the dynamic inference requirement of the user, the user can be allowed to add attribute constraints for the start node and/or the end node of the virtual edge to the virtual edge generation rule. Based on this, for the virtual edge generation rule in the inference request of the user, when the node constraints in the generation rule include the first-type constraint and the second-type constraint described above, the node constraints can further include a first attribute constraint on the start node and/or a second attribute constraint on the end node. Alternatively, when the node constraints include the target constraint described above, and the target constraint includes the type constraint on the end node, the target constraint can further include an attribute constraint on the end node.

It should be noted that the attribute constraint in the node constraints can be defined in a form of an objective function. For an explanation of the objective function, refer to the above-mentioned related descriptions. Details are not repeated herein. It should be noted that when both the attribute constraint and the relationship constraint described above are defined based on the objective function, the function body of the objective function has relationship constraint logic for the relationship between the start node and the end node of the virtual edge, and attribute constraint logic for an attribute of the start node and/or an attribute of the end node.

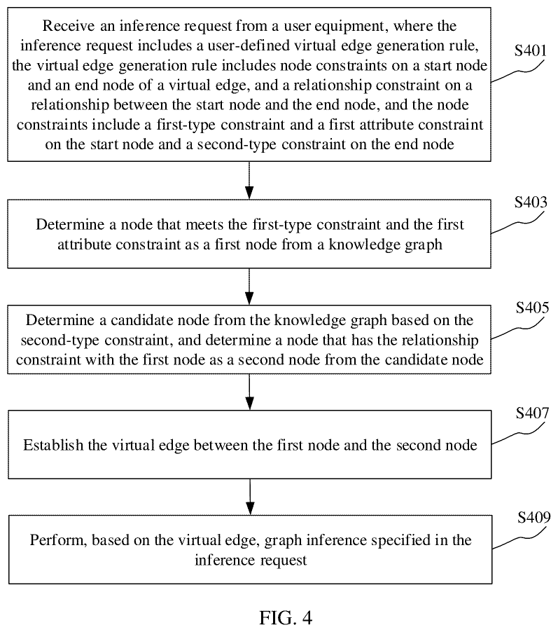

The following describes a specific inference process with reference to FIG. 4 by using an example in which node constraints include a first-type constraint, a second-type constraint, and a first attribute constraint. FIG. 4 is another flowchart of a knowledge graph-based inference method according to an embodiment. The method can be performed by the inference engine 101 and includes steps S401 to S409 as an example.

As shown in FIG. 4, in step S401, an inference request is received from a user equipment, where the inference request includes a user-defined virtual edge generation rule, the virtual edge generation rule includes node constraints on a start node and an end node of a virtual edge, and a relationship constraint on a relationship between the start node and the end node, and the node constraints include a first-type constraint and a first attribute constraint on the start node and a second-type constraint on the end node.

For an explanation of step S401, refer to the above-mentioned related descriptions. Details are not repeated herein.

Then, in step S403, a node that meets the first-type constraint and the first attribute constraint is determined as a first node from the knowledge graph 102.

In an example, node information of all nodes that meet the first-type constraint can be obtained from the knowledge graph 102. The node information includes attribute information. For each node in the nodes, if attribute information of the node meets the first attribute constraint, the node is used as the first node.

Then, in step S405, a candidate node is determined from the knowledge graph 102 based on the second-type constraint, and a node that has the relationship constraint with the first node is determined as a second node from the candidate node.

When the node constraints do not include the second attribute constraint described above, a node that meets the second-type constraint in the knowledge graph 102 can be directly determined as the candidate node. When the node constraints further include a second attribute constraint, a node that meets both the second-type constraint and the second attribute constraint in the knowledge graph 102 can be determined as the candidate node.

Then, in step S407, the virtual edge is established between the first node and the second node.

Then, in step S409, graph inference specified in the inference request is performed based on the virtual edge.

For explanations of steps S407 and S409, refer to the above-mentioned related descriptions. Details are not repeated herein.

The following describes the embodiment of FIG. 4 by still using an example in which a graph pattern and graph data of the knowledge graph 102 are the graph pattern 201 and the graph data 202 shown in FIG. 2.

It is assumed that there is an inference requirement to infer a bank to which a credit card of a user located in city A described in the knowledge graph 102 belongs. A virtual edge generation rule can be defined to include a first-type constraint used to limit a node type of a start node of a virtual edge to User, a first-type constraint used to limit an attribute value of a location attribute of the start node to be equal to “City A”, a second-type constraint used to limit a node type of an end node of the virtual edge to CreditCard, and a relationship constraint used to limit a node ID of the end node to be equal to an attribute value of a credit card number attribute of the start node. Then, an inference request can be sent to the inference engine 101, where the inference request includes the generation rule, and requests to obtain node information of a node that has an actual connecting edge with the end node of the virtual edge and that belongs to a node type Bank.

After receiving the inference request, the inference engine 101 can determine a user 1 node that meets the first-type constraint and the first attribute constraint, and a credit card 1 node and a credit card 2 node that meet the second-type constraint from the knowledge graph 102. Then, by comparing respective node IDs of the credit card 1 node and the credit card 2 node with an attribute value “123” of a credit card number attribute of the user 1 node, the inference engine 101 can learn that only the credit card 1 node has the relationship constraint with the user 1 node, and therefore establish a virtual edge e1 from the user 1 node to the credit card 1 node. Then, the inference engine 101 can determine a bank 1 node that has an actual connecting edge with an end node (that is, the credit card 1 node) of the virtual edge e1 from the knowledge graph 102 based on a node ID of the end node and the edge type Belongs, and obtain node information of the bank 1 node. The node information includes but is not limited to a name of a bank represented by the bank 1 node. Then, the inference engine 101 can generate an inference result based on the obtained node information. The inference result can indicate that a bank to which a credit card of a user 1 belongs includes a bank 1.

In the embodiment of FIG. 4, a user-defined virtual edge generation rule is allowed to include node constraints on a start node and an end node of a virtual edge, and a relationship constraint on a relationship between the start node and the end node, and the node constraints include a first-type constraint and a first attribute constraint on the start node and a second-type constraint on the end node. The virtual edge generation rule is included in an inference request, so that a first node that meets both the first-type constraint and the first attribute constraint and a second node that meets the second-type constraint and that has the relationship constraint with the first node can be determined from a knowledge graph based on the virtual edge generation rule in the inference request, the virtual edge can be established between the first node and the second node, and graph inference specified in the inference request can be performed based on the virtual edge. In this way, a dynamic inference requirement of the user can be better met, and costs of constructing and storing graph data can be lowered. Accordingly, utilization of an existing knowledge graph can be improved, and memory space can be saved by not constructing a complete new knowledge graph for storing graph data.

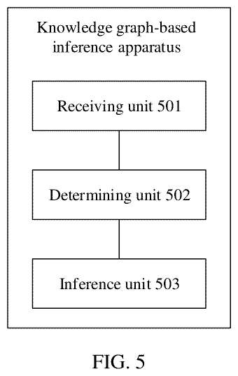

FIG. 5 is a schematic diagram of a knowledge graph-based inference apparatus, according to an embodiment. The apparatus can be applied to an inference engine and includes: a receiving unit 501, configured to receive an inference request from a user equipment, where the inference request includes a user-defined virtual edge generation rule, and the generation rule includes node constraints on a start node and an end node of a virtual edge, and a relationship constraint on a relationship between the start node and the end node; a determining unit 502, configured to determine, based on the generation rule, the virtual edge between a first node and a second node that do not have an actual connecting edge in a knowledge graph; and an inference unit 503, configured to perform, based on the virtual edge, graph inference specified in the inference request.

In an implementation, the node constraints include at least a first-type constraint on the start node and a second-type constraint on the end node.

In an implementation, the determining unit 502 can be further configured to: determine the first node based on the first-type constraint; determine a candidate node based on the second-type constraint, and determine a node that has the relationship constraint with the first node as the second node from the candidate node; and establish the virtual edge between the first node and the second node.

In an implementation, the node constraints further include a first attribute constraint on the start node; and the determining unit 502 can be further configured to determine a node that meets the first-type constraint and the first attribute constraint as the first node.

In an implementation, the node constraints further include a second attribute constraint on the end node; and the determining unit 502 can be further configured to determine a node that meets the second-type constraint and the second attribute constraint as the candidate node.

In an implementation, the attribute constraint in the node constraints is defined in a form of an objective function.

In an implementation, the node constraints include an identifier of a specified start node and a target constraint on the end node; and the determining unit 502 can be further configured to: determine the first node based on the identifier; determine a node that has the relationship constraint with the first node as the second node from a candidate node that meets the target constraint; and establish the virtual edge between the first node and the second node.

In an implementation, the relationship constraint is a default preset logical relationship.

In an implementation, the preset logical relationship includes that a node ID of the end node is equal to a specific attribute value of the start node.

In an implementation, the relationship constraint is defined based on an objective function, and the objective function is used to constrain an attribute of the start node and/or an attribute of the end node.

In an implementation, the inference request requests to obtain node information of the end node of the virtual edge; and the inference unit 503 can be further configured to: obtain node information of the second node from the knowledge graph; and generate an inference result based on the obtained node information.

In an implementation, the inference request requests to obtain node information of a third node that has an actual connecting edge with the end node of the virtual edge; and the inference unit 503 can be further configured to: determine a third node that has an actual connecting edge with the second node from the knowledge graph, and obtain node information of the third node; and generate an inference result based on the obtained node information.

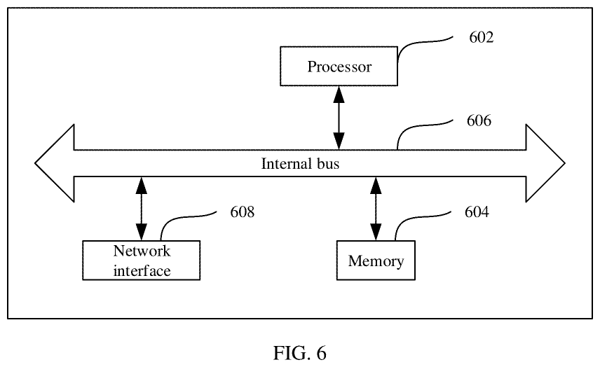

FIG. 6 is a schematic diagram of a knowledge graph-based inference apparatus, according to an embodiment. The apparatus includes a processor 602 and a memory 604 storing instructions executable by the processor 602. The apparatus may also include an internal bus 606, a network interface 608, or other hardware as needed. The processor 602 is configured to perform the above described knowledge graph-based inference method including: receiving an inference request from a user equipment, wherein the inference request includes a user-defined virtual edge generation rule, and the generation rule includes node constraints on a start node and an end node of a virtual edge, and a relationship constraint on a relationship between the start node and the end node; determining, based on the generation rule, the virtual edge between a first node and a second node that do not have an actual connecting edge in the knowledge graph; and performing, based on the virtual edge, graph inference specified in the inference request.

In some embodiments, the node constraints include at least a first-type constraint on the start node and a second-type constraint on the end node.

In some embodiments, determining the virtual edge includes: determining the first node based on the first-type constraint; determining a candidate node based on the second-type constraint, and determining a node that has the relationship constraint with the first node as the second node from the candidate node; and establishing the virtual edge between the first node and the second node.

In some embodiments, the node constraints further include a first attribute constraint on the start node; and determining the first node based on the first-type constraint includes: determining a node that meets the first-type constraint and the first attribute constraint as the first node.

In some embodiments, the node constraints further include a second attribute constraint on the end node; and determining a candidate node based on the second-type constraint includes: determining a node that meets the second-type constraint and the second attribute constraint as the candidate node.

In some embodiments, the attribute constraint in the node constraints is defined in a form of an objective function.

In some embodiments, the node constraints include an identifier of a specified start node and a target constraint on the end node; and determining the virtual edge includes: determining the first node based on the identifier; determining a node that has the relationship constraint with the first node as the second node from a candidate node that meets the target constraint; and establishing the virtual edge between the first node and the second node.

In some embodiments, the relationship constraint is a default preset logical relationship.

In some embodiments, the preset logical relationship includes that a node ID of the end node is equal to a specific attribute value of the start node.

In some embodiments, the relationship constraint is defined based on an objective function, and the objective function is used to constrain an attribute of the start node and/or an attribute of the end node.

In some embodiments, the inference request requests to obtain node information of the end node of the virtual edge; and performing, based on the virtual edge, graph inference specified in the inference request includes: obtaining node information of the second node from the knowledge graph; and generating an inference result based on the obtained node information.

In some embodiments, the inference request requests to obtain node information of a third node that has an actual connecting edge with the end node of the virtual edge; and performing, based on the virtual edge, graph inference specified in the inference request includes: determining a third node that has an actual connecting edge with the second node from the knowledge graph, and obtaining node information of the third node; and generating an inference result based on the obtained node information.

An embodiment of this specification further provides a computer-readable storage medium. The computer-readable storage medium stores a computer program. When the computer program is executed by a processor, the processor is caused to perform the method described above.

A person skilled in the art will understand that each unit or feature described above can be implemented by hardware, software, firmware, or any combination thereof. When being implemented by software, these functions can be stored in a computer-readable medium or transmitted as one or more instructions or code on a computer-readable medium.

In some cases, the actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multi-tasking and parallel processing are also possible or may be advantageous.

It should be understood that the above descriptions are merely specific implementations of example embodiments of this specification, but are not intended to limit the protection scope of this specification. Any modification, equivalent replacement, improvement, etc. made based on the example embodiments of this specification shall fall within the protection scope of this specification.

1. A knowledge graph-based inference method, comprising:
receiving an inference request from a user equipment, wherein the inference request comprises a user-defined virtual edge generation rule, and the generation rule comprises node constraints on a start node and an end node of a virtual edge, and a relationship constraint on a relationship between the start node and the end node;
determining, based on the generation rule, the virtual edge between a first node and a second node that do not have an actual connecting edge in the knowledge graph; and
performing, based on the virtual edge, graph inference specified in the inference request.

2. The method according to claim 1, wherein the node constraints comprise at least a first-type constraint on the start node and a second-type constraint on the end node.

3. The method according to claim 2, wherein the determining the virtual edge comprises:
determining the first node based on the first-type constraint;
determining a candidate node based on the second-type constraint, and determining a node that has the relationship constraint with the first node as the second node from the candidate node; and
establishing the virtual edge between the first node and the second node.

4. The method according to claim 3, wherein the node constraints further comprise an attribute constraint on the start node; and
the determining the first node based on the first-type constraint comprises:
determining a node that meets the first-type constraint and the attribute constraint as the first node.

5. The method according to claim 3, wherein the node constraints further comprise an attribute constraint on the end node; and
the determining a candidate node based on the second-type constraint comprises:
determining a node that meets the second-type constraint and the attribute constraint as the candidate node.

6. The method according to claim 4, wherein the attribute constraint in the node constraints is defined in a form of an objective function.

7. The method according to claim 1, wherein the node constraints comprise an identifier of a specified start node and a target constraint on the end node; and
the determining the virtual edge comprises:
determining the first node based on the identifier;
determining a node that has the relationship constraint with the first node as the second node from a candidate node that meets the target constraint; and
establishing the virtual edge between the first node and the second node.

8. The method according to claim 1, wherein the relationship constraint is a default preset logical relationship.

9. The method according to claim 8, wherein the preset logical relationship comprises that a node ID of the end node is equal to a specific attribute value of the start node.

10. The method according to claim 1, wherein the relationship constraint is defined based on an objective function, and the objective function is configured to constrain at least one of an attribute of the start node or an attribute of the end node.

11. The method according to claim 1, wherein the inference request requests to obtain node information of the end node of the virtual edge; and
the performing, based on the virtual edge, graph inference specified in the inference request comprises:
obtaining node information of the second node from the knowledge graph; and
generating an inference result based on the obtained node information.

12. The method according to claim 1, wherein the inference request requests to obtain node information of a third node that has an actual connecting edge with the end node of the virtual edge; and
the performing, based on the virtual edge, graph inference specified in the inference request comprises:
determining a third node that has an actual connecting edge with the second node from the knowledge graph, and obtaining node information of the third node; and
generating an inference result based on the obtained node information.

13. A knowledge graph-based inference apparatus, comprising:
a processor; and
a memory storing instructions executable by the processor,
wherein the processor is configured to:
receive an inference request from a user equipment, wherein the inference request comprises a user-defined virtual edge generation rule, and the generation rule comprises node constraints on a start node and an end node of a virtual edge, and a relationship constraint on a relationship between the start node and the end node;
determine, based on the generation rule, the virtual edge between a first node and a second node that do not have an actual connecting edge in the knowledge graph; and
perform, based on the virtual edge, graph inference specified in the inference request.

14. The apparatus according to claim 13, wherein the node constraints comprise at least a first-type constraint on the start node and a second-type constraint on the end node.

15. The apparatus according to claim 14, wherein the processor is further configured to:
determine the first node based on the first-type constraint;
determine a candidate node based on the second-type constraint, and determining a node that has the relationship constraint with the first node as the second node from the candidate node; and
establish the virtual edge between the first node and the second node.

16. The apparatus according to claim 15, wherein the node constraints further comprise an attribute constraint on the start node; and
the processor is further configured to:
determine a node that meets the first-type constraint and the attribute constraint as the first node.

17. The apparatus according to claim 15, wherein the node constraints further comprise an attribute constraint on the end node; and
the processor is further configured to:
determine a node that meets the second-type constraint and the attribute constraint as the candidate node.

18. The apparatus according to claim 16, wherein the attribute constraint in the node constraints is defined in a form of an objective function.

19. The apparatus according to claim 13, wherein the node constraints comprise an identifier of a specified start node and a target constraint on the end node; and
the processor is further configured to:
determine the first node based on the identifier;
determine a node that has the relationship constraint with the first node as the second node from a candidate node that meets the target constraint; and
establish the virtual edge between the first node and the second node.

20. A non-transitory computer-readable storage medium storing instructions that, when executed by a processor, cause the processor to perform the computer is enabled to perform a knowledge graph-based inference method, the method comprising:
receiving an inference request from a user equipment, wherein the inference request comprises a user-defined virtual edge generation rule, and the generation rule comprises node constraints on a start node and an end node of a virtual edge, and a relationship constraint on a relationship between the start node and the end node;
determining, based on the generation rule, the virtual edge between a first node and a second node that do not have an actual connecting edge in the knowledge graph; and
performing, based on the virtual edge, graph inference specified in the inference request.
